(19) United States
(12) Patent Application Publication
(10) Pub. No.: US 2013/0241961 A1
(43) Pub. Date: Sep. 19, 2013

(54) ELECTROPHORETIC DISPLAY DEVICE AND METHOD FOR DRIVING THE SAME

(71) Applicants: Chi-ming LU, Puxin Township (TW); Yun-zhi CHEN, Taoyuan City (TW); Hung-hsiang CHEN, Zhongli City (TW)

(72) Inventors: Chi-ming LU, Puxin Township (TW); Yun-zhi CHEN, Taoyuan City (TW); Hung-hsiang CHEN, Zhongli City (TW)

(73) Assignee: CHUNGHWA PICTURE TUBES, LTD., Bade City (TW)

(21) Appl. No.: 13/470,315

(22) Filed: May 13, 2012

(30) Foreign Application Priority Data
Mar. 13, 2012 (TW) 101108491

(51) Int. Cl. G09G 5/10; G09G 3/36

(52) U.S. Cl. 345/690; 345/89

(57) ABSTRACT

Disclosed are an electrophoretic display device and a method for driving the same. The electrophoretic display device includes a first electrode layer, a second electrode layer, an electrophoretic layer, and a controller. The first electrode layer includes a plurality of pixels formed thereon. The electrophoretic layer is disposed between the first electrode layer and the second electrode layer. The controller looks up a write-in gray level data of each pixel in each frame from a lookup table. The lookup table records the write-in gray level data of each pixel in each frame when a gray level of each pixel is changed from a reference gray level to a required gray level. The present invention is capable of decreasing the lookup table size.

### TECHNICAL FIELD OF THE INVENTION

The present invention relates to an electrophoretic display device, and more particularly to an electrophoretic display device and a method for driving the same.

### BACKGROUND OF THE INVENTION

Please refer to FIG. 1, which illustrates displaying principle of a conventional electrophoretic display device. The electrophoretic display device mainly comprises a first substrate 100, a second substrate 102, an electrode layer 104 which is disposed on the first substrate 100, an electrophoretic layer 106 which is disposed between the first substrate 100 and the second substrate 102, and a driving circuit 108. The electrophoretic layer 106 comprises a plurality of charged particles having white charged particles 110 and black charged particles 112. The white charged particles 110 are positively charged particles, while the black charged particles are negatively charged particles. The driving circuit 108 is utilized for providing data voltages to the electrode layer 104. A common voltage is applied to another electrode layer (not shown) on the second substrate 102. The white charged particles 110 and the black charged particles 112 are driven by an electric field formed by the data voltages and the common voltage, so as to change locations of the white charged particles 110 and the black charged particles 112 for displaying images.

Please refer to FIG. 2 and FIG. 3. FIG. 2 illustrates a graph showing a relationship between the driving time and the gray level in the conventional electrophoretic display device. FIG. 3 illustrates the locations of the white charged particles versus the corresponding gray levels. As shown in FIG. 2, when the driving time of the charged particles is short, the gray level is low. When the driving time of the charged particles is long, the gray level is high. Further, as shown in FIG. 3, when the white charged particles 110 are further away from the top surface of the electrophoretic display device (i.e. at the lower location in FIG. 3), the gray level is low. When the white charged particles 110 are closer to the top surface of the electrophoretic display device (i.e. at the upper location in FIG. 3), the gray level is high. By changing the locations of the white charged particles 100 to reflect light received from the environment, the electrophoretic display device is capable of showing the color contrast of the white charged particles 100 for displaying the images. The aforesaid displaying principle is known as a total reflective display technology. Thus, the electrophoretic display device does not require a backlight source.

A color electrophoretic display device is manufactured by disposing a color filter (CF) on the electrophoretic display device in FIG. 1.

Please refer to FIG. 4 and FIG. 5. FIG. 4 illustrates a system architecture of the conventional electrophoretic display device. FIG. 5 illustrates a conventional lookup table architecture. In the system architecture, a frame buffer 400 is required to store a previous image F(N−1). A current image F(N) and the previous image F(N−1) are inputted to a controller 402. The controller 402 looks up a gray level data of each frame in the current image F(N) which are required to be provided to an electrophoretic display panel 404 from the lookup table 406.

As shown in FIG. 5, when one image of the conventional electrophoretic display device comprises K frames, K lookup tables are required to be stored. In a first frame, a value is obtained by looking up an input gray level (i.e. a gray level of a pixel of the previous image F(N−1)) versus an output gray level (i.e. a gray level of the pixel of the current image F(N−1)) from a first lookup table and provided to the electrophoretic display panel 404. Then, the values required from a second frame to a K-th frame are obtained by respectively looking up from a second lookup table to a K-th lookup table.

Accordingly, when the system architecture is applied to the color electrophoretic display device, a lookup table capacity is equal to 3 (i.e. red, green, blue)×16 (i.e. total input gray levels)×16 (i.e. total output gray levels)×K (i.e. total frames)=768×K bits. An output voltage being outputted by a source driving circuit lasts for 16.7 milliseconds (ms) at a frame rate of 60 Hz (Hertz). Currently, a response time of the charged particles is about 250 ms to 350 ins. Updating a complete image requires 15 to 21 multiples of a frame time (250 ms/16.7 ms to 350 ms/16.7 ms). That is, K is about 15 to 21 frames. Accordingly, the required lookup table capacity of the color electrophoretic display device is between (768×15) and (768×21)=11.52 k bits and 16.13 k bits, and thus the memory cost is too high.

Since the required lookup table capacity is too high, only one group of the lookup tables as shown in FIG. 5 can be stored. It fails to store several groups of the lookup tables for different situations. For instance, different groups of the lookup tables are looked up according to different temperatures. Accordingly, the values which are looked up from the conventional lookup table architecture are not accurate, so that the display quality is poor or color shift phenomenon occurs.

Therefore, there is a need for a solution to the above-mentioned problems that the memory cost is too high and the display quality is poor.

### SUMMARY OF THE INVENTION

An objective of the present invention is to provide an electrophoretic display device and a method for driving the same, which are capable of decreasing the memory cost and improving the display quality.

To achieve the above-mentioned objective, an electrophoretic display device according to an aspect of the present invention is provided. The electrophoretic display device is used for displaying at least one image. The image comprises a plurality of frames. The electrophoretic display device comprises a first electrode layer, a second electrode layer, an electrophoretic layer, and a controller. The first electrode layer has a plurality of pixels formed thereon. The second electrode layer is corresponding to the first electrode layer and electrically coupled to a common voltage. The electrophoretic layer is disposed between the first electrode layer and the second electrode layer and comprises a plurality of charged particles. Each of the pixels is corresponding to several of the charged particles. The controller receives a display data corresponding to the image. The display data comprises a required gray level for each of the pixels. The controller looks up a write-in gray level data of each of the pixels in each of the frames from at least one lookup table according to the required gray level for determining a voltage. The lookup table records the write-in gray level data of each of the pixels in each of the frames from a reference gray level to the required gray level. The voltage is provided to the first electrode layer. An electric field is formed between the first electrode layer and the second electrode layer through each of the pixels for driving the charged particles corresponding to each of the pixels.

To achieve the above-mentioned objective, a method for driving an electrophoretic display device according to another aspect of the present invention is provided. The electrophoretic display device comprises a first electrode layer, a second electrode layer corresponding to the first electrode layer, and an electrophoretic layer which is disposed between the first electrode layer and the second electrode layer. The first electrode layer has a plurality of pixels formed thereon. The electrophoretic layer comprises a plurality of charged particles. Each of the pixels is corresponding to several of the charged particles. The electrophoretic display device is used for displaying at least one image. The image comprises a plurality of frames. The method comprises the steps of receiving a display data corresponding to the image, the display data comprising a required gray level for each of the pixels; looking up a write-in gray level data of each of the pixels in each of the frames from at least one lookup table according to the required gray level for each of the pixels, the lookup table recording the write-in gray level data of each of the pixels in each of the frames from a reference gray level to the required gray level; providing a voltage to the first electrode layer according to the write-in gray level data in each of the frames; and providing a common voltage to the second electrode layer, and an electric field being formed between the first electrode layer and the second electrode layer through each of the pixels for driving the charged particles corresponding to each of the pixels.

The electrophoretic display device and the method for driving the same according to the present invention are capable of significantly decreasing the lookup table capacity, thereby decreasing the hardware cost.

### BRIEF DESCRIPTION OF THE DRAWINGS

FIG. 1 illustrates displaying principle of a conventional electrophoretic display device;

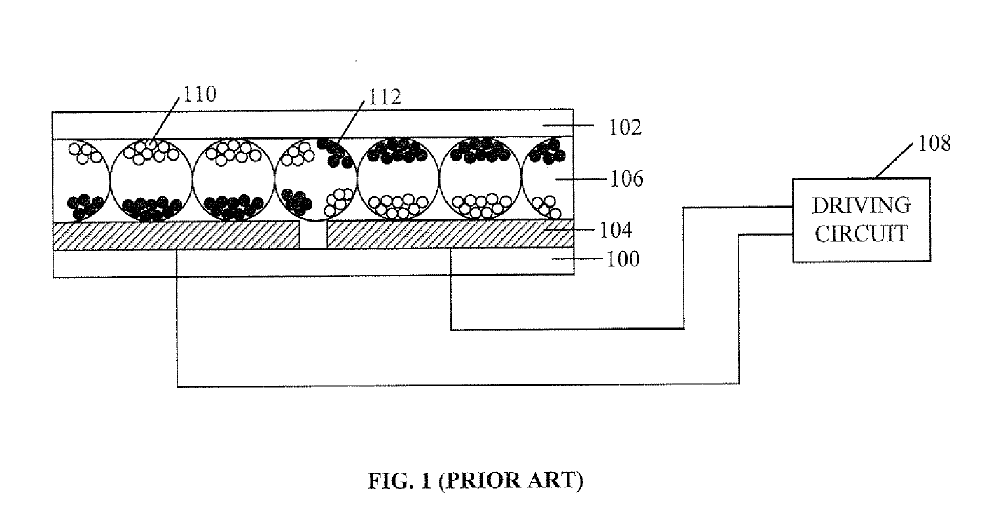

FIG. 2 illustrates a graph showing a relationship between the driving time and the gray level in the conventional electrophoretic display device;

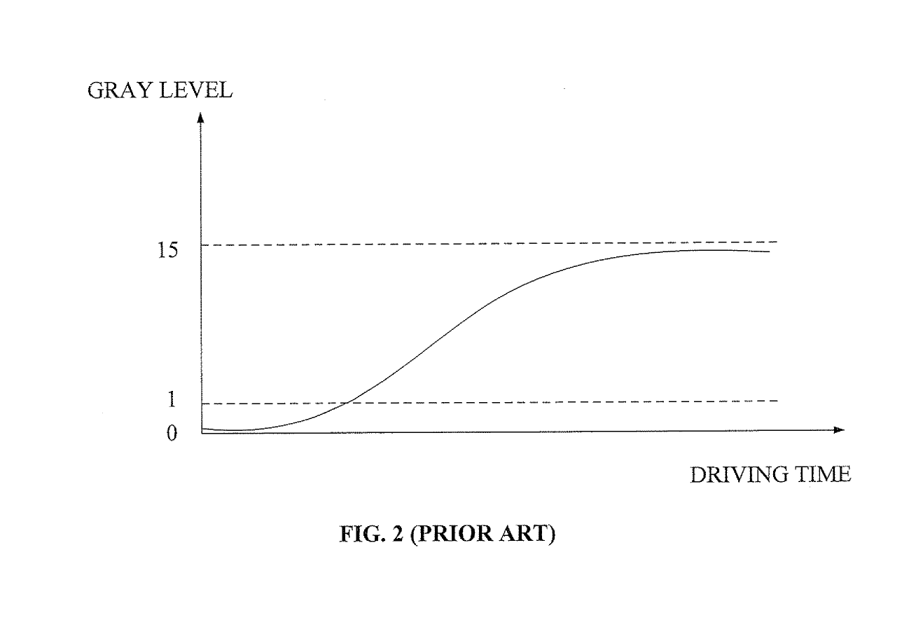

FIG. 3 illustrates the locations of the white charged particles versus the corresponding gray levels;

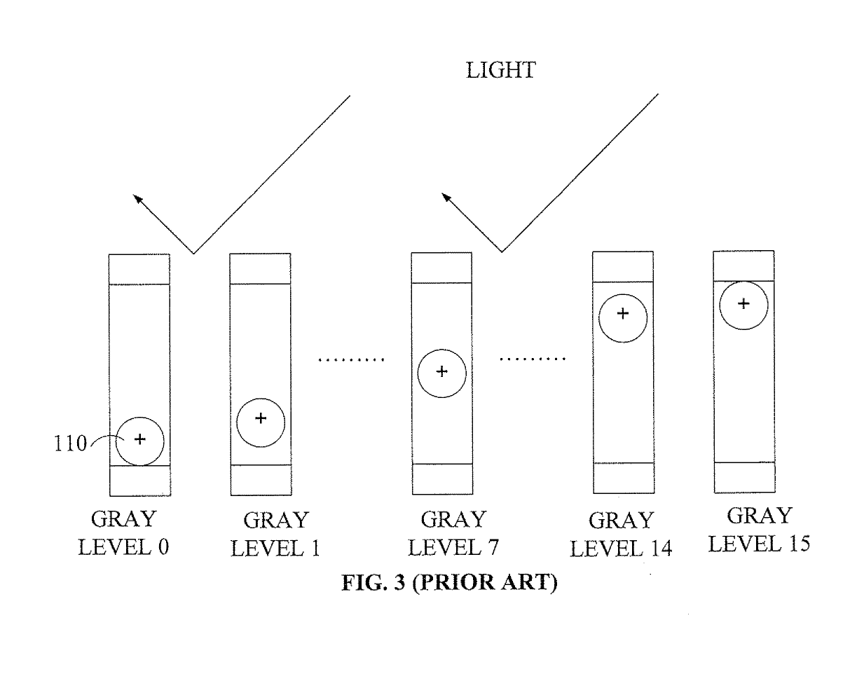

FIG. 4 illustrates a system architecture of the conventional electrophoretic display device;

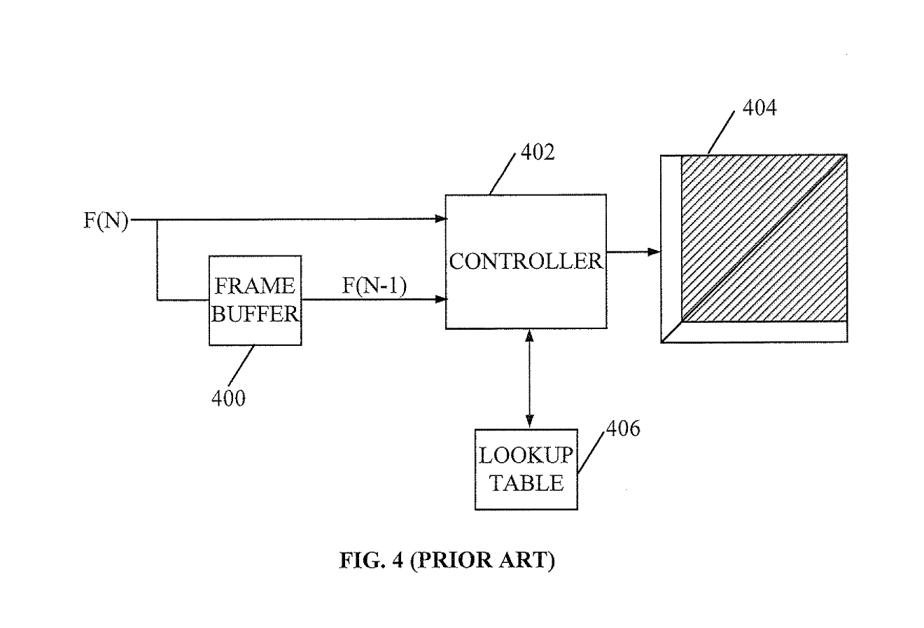

FIG. 5 illustrates a conventional lookup table architecture;

FIG. 6 illustrates a system architecture of an electrophoretic display device according to a preferred embodiment of the present invention;

FIG. 7 illustrates pixels of an electrophoretic display panel in FIG. 6;

FIG. 8 illustrates a timing chart showing the source data signal inputted to the source driving circuit by the controller; and

FIG. 9 illustrates a flow chart of a method for driving an electrophoretic display device according to the present invention.

### DETAILED DESCRIPTION OF THE INVENTION

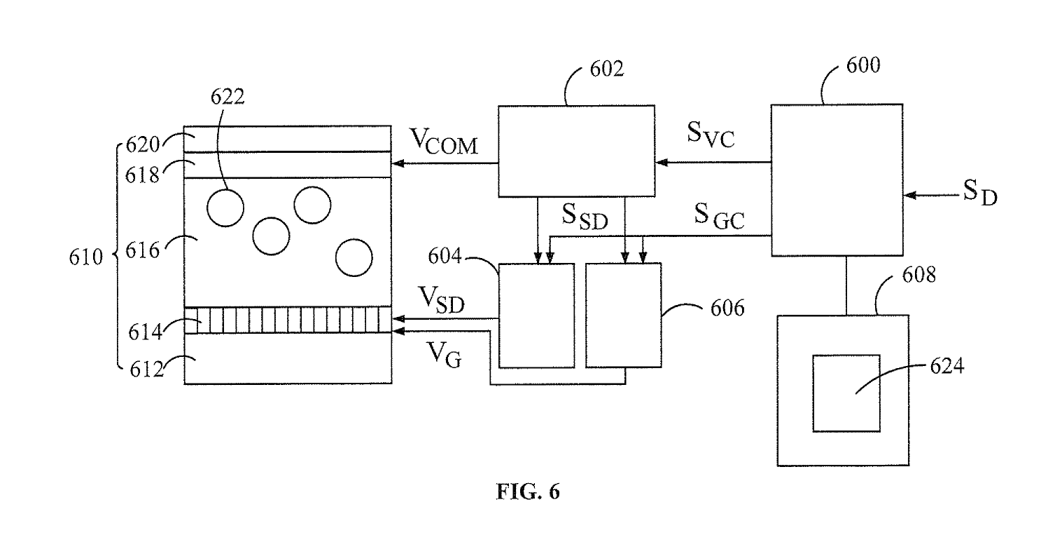

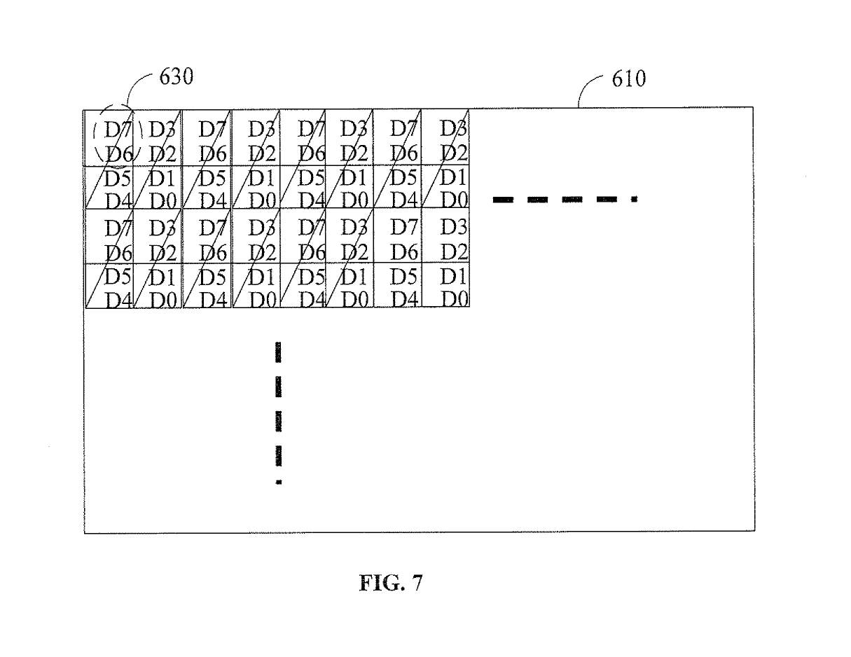

Please refer to FIG. 6 and FIG. 7. FIG. 6 illustrates a system architecture of an electrophoretic display device according to a preferred embodiment of the present invention. FIG. 7 illustrates pixels of an electrophoretic display panel in FIG. 6. The electrophoretic display device is utilized for displaying at least one image. The image comprises a plurality of frames. The electrophoretic display device comprises a controller 600, a power supply unit 602, a source driving circuit 604, a gate driving circuit 606, a memory unit 608, and the electrophoretic display panel 610.

The electrophoretic display panel 610 comprises a first substrate 612, a first electrode layer 614, an electrophoretic layer 616, a second electrode layer 618, and a second substrate 620. In the present embodiment, the first substrate 612 is a thin film transistor (TFT) substrate. The first electrode layer 614 has a plurality of pixels 630 formed thereon and is an indium tin oxide (ITO) layer being manufactured on the first substrate 612. The second substrate 620 is a color filter substrate. The second electrode layer 618 is an ITO layer being manufactured on the second substrate 620. The second electrode layer 618 may be regarded as a common electrode layer corresponding to the first electrode layer 614. An electric field formed between the first electrode layer 614 and the second electrode layer 618 through each of the pixels 630 drives a plurality of charged particles 622 corresponding to each of the pixels 630 to move to different locations for generating different gray levels. The charged particles 622 may be positively charged particles or negatively charged particles. The color of the charged particles 622 may be white or black.

When an image is required to be displayed, a display data S_{D} corresponding to the image is first inputted to the controller 600. The display data S_{D} comprises a required gray level for each of the pixels 630. The controller 600 looks up a write-in gray level data (i.e. a gray level data is required to be written in each of the frames) of each of the pixels 630 in each of the frames from a lookup table 624 stored in the memory unit 608 according to the required gray level, and then outputs a source data signal S_{SD} to the source driving circuit 604 according to the write-in gray level data which is looked up from the lookup table 624. Furthermore, the controller 600 outputs a voltage controlling signal S_{VC} to the power supply unit 602 so as to control an output voltage from the power supply unit 602 according to the display data S_{D}, as well as outputs a gate controlling signal S_{GC} to the gate driving circuit 606.

The power supply unit 602 outputs a common voltage V_{COM} to the second electrode layer 618 according to the voltage controlling signal S_{VC}. The source driving circuit 604 selects a required voltage from the power supply unit 602 according to the source data signal S_{SD}. The gate driving circuit 606 selects a required voltage from the power supply unit 602 according to the gate controlling signal S_{GC}. The gate driving circuit 606 and the source driving circuit 604 respectively transform the required voltages selected from the power supply unit 602 into a gate voltage V_{G} and a source driving voltage V_{SD}. Then, the gate voltage V_{G} and the source driving voltage V_{SD} are outputted to TFTs (not shown) of the pixels 630 on the first substrate 612. The gate voltage V_{G} is utilized for turning on and off the TFTs. The charged particles 622 in the electrophoretic layer 616 are driven to different locations for generating different gray levels by the electric field being formed by the source driving voltage V_{SD} and the common voltage V_{COM} of the second electrode layer 618.

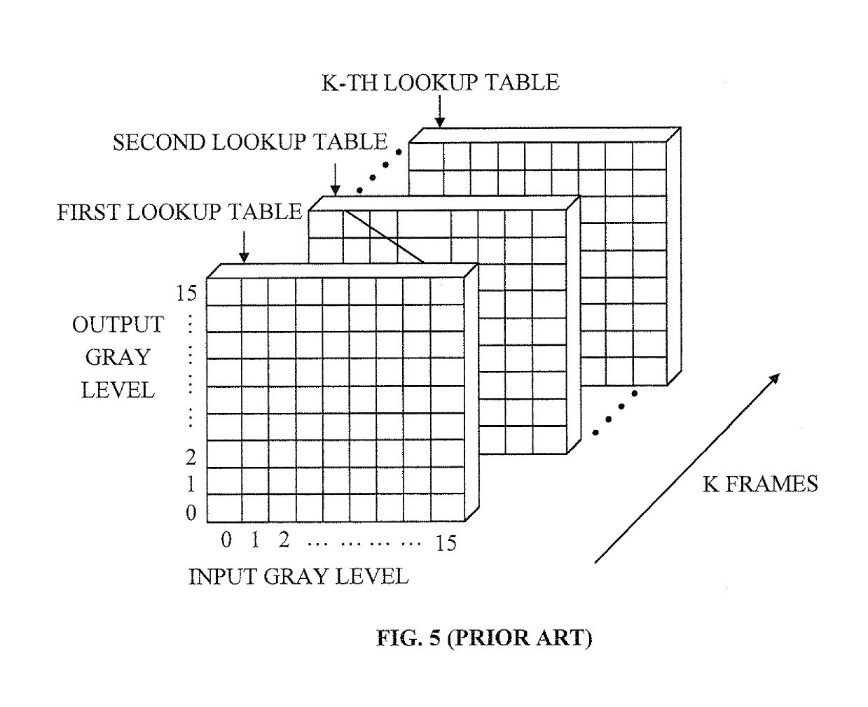

Compared with the conventional lookup table architecture in FIG. 5, the capacity of the lookup table 624 can be significantly decreased according to the present invention, thus the cost of the memory unit 608 can be reduced. The following reason will explain how the capacity of the lookup table 624 can be decreased according to the present invention.

Owing to the material characteristics of the charged particles 622, the charged particles 622 have to be driven back to an initial location (i.e. corresponding to a lowest gray level or a highest gray level) for removing a previous gray level data when updating an image. Then, a current gray level data is written in. The charged particles 622 that are driven back to the initial location means that the charged particles 622 are driven back to a black location (i.e. corresponding to the lowest gray level) or a white location (i.e. corresponding to the highest gray level). In fact, when the charged particles 622 are driven back to the black location (i.e. corresponding to the lowest gray level) and then back to the white location (i.e. corresponding to the highest gray level) for several times, the effect of removing the previous gray level data is better.

By using the characteristics that the gray level data can be written in only when the charged particles 622 are driven back to the black location (i.e. corresponding to the lowest gray level) or the white location (i.e. corresponding to the highest gray level), the lookup table 624 according to the present invention only requires to record the write-in gray level data in each of the frames from the lowest gray level or the highest gray level to the required gray level.

Please refer to the following TABLE 1, which shows the lookup table according to the present invention. If an image is assumed to comprise K frames and be capable of displaying 16 gray levels (i.e. G0-G15). Currently, voltages for driving the charged panicles 622 comprise three voltages: +15 volts (V_{POS}), −15 volts (V_{NEG}), and 0 volt (V_{SS}). As a result, a two-bit data is required for representing the three voltages.

The write-in gray level data in each of the frames is obtained by experimenting on the charged particles 622. That is, the charged particles 622 have to be measured to obtain a relationship between the driving time and the gray level, and therefore the write-in gray level data in each of the frames is determined according to the relationship between the driving time and the gray level. For example, when the required gray level is G13, the write-in gray level in the frame 1 is D₂₇D₂₆, while the write-in gray level in the final frame K is D_{27′}D_{26′}.

TABLE 1

| | frame | | | | | | | | | | | | | | |
|---|---|---|---|---|---|---|---|---|---|---|---|---|---|---|---|
| required gray level | 1 | 2 | 3 | . . . | . . . | . . . | . . . | . . . | . . . | . . . | . . . | . . . | . . . | . . . | K |
| G15 | D₃₁D₃₀ | . . . | . . . | . . . | . . . | . . . | . . . | . . . | . . . | . . . | . . . | . . . | . . . | . . . | D₃₁′D₃₀′ |
| G14 | D₂₉D₂₈ | . . . | . . . | . . . | . . . | . . . | . . . | . . . | . . . | . . . | . . . | . . . | . . . | . . . | D₂₉′D₂₈′ |
| G13 | D₂₇D₂₆ | . . . | . . . | . . . | . . . | . . . | . . . | . . . | . . . | . . . | . . . | . . . | . . . | . . . | D₂₇′D₂₆′ |
| . . . | . . . | . . . | . . . | . . . | . . . | . . . | . . . | . . . | . . . | . . . | . . . | . . . | . . . | . . . | . . . |
| . . . | . . . | . . . | . . . | . . . | . . . | . . . | . . . | . . . | . . . | . . . | . . . | . . . | . . . | . . . | . . . |
| G2 | D₅D₄ | . . . | . . . | . . . | . . . | . . . | . . . | . . . | . . . | . . . | . . . | . . . | . . . | . . . | D₅′D₄′ |
| G1 | D₃D₂ | . . . | . . . | . . . | . . . | . . . | . . . | . . . | . . . | . . . | . . . | . . . | . . . | . . . | D₃′D₂′ |
| G0 | D₁D₀ | . . . | . . . | . . . | . . . | . . . | . . . | . . . | . . . | . . . | . . . | . . . | . . . | . . . | D₁′D₀′ |

Please refer to the following TABLE 2 and TABLE 3. TABLE 2 shows an example of the lookup table according to the present invention. TABLE 3 shows the write-in gray level data versus the voltages. In the present example, the response time of the charged particles 622 is 300 ms and a frame rate is 60 Hz, that is, updating a complete image requires 18 multiples of a frame time (300 ms/16.7 ms=18). The charged particles 622 are assumed to be back to the white location (i.e. the highest gray level). When the required gray level is G15 (i.e. the highest gray level), the gray level is not required to be changed. Accordingly, the write-in gray level data in the frames 1-18 are “10”. It can be seen from TABLE 3 that “10” represents 0 volt, and thus the gray level is not changed. When the required gray level is G9, it can be seen from TABLE 2 and TABLE 3 that the write-in gray level data in the frames 1-12 are “10” representing 0 volt and the write-in gray level data in the frames 13-18 are “01” representing −15 volts. When the required gray level is G0 (i.e. the lowest gray level), it can be seen from TABLE 2 that the write-in gray level data in the frames 1-18 are “01”. This means that −15 volts is required to be inputted in all frames, such that the highest gray level can be changed to the lowest gray level.

TABLE 2

| required gray | frame | | | | | | | | | | | | | | | | | |
|---|---|---|---|---|---|---|---|---|---|---|---|---|---|---|---|---|---|---|
| level | 1 | 2 | 3 | 4 | 5 | 6 | 7 | 8 | 9 | 10 | 11 | 12 | 13 | 14 | 15 | 16 | 17 | 18 |
| G15 | 10 | 10 | 10 | 10 | 10 | 10 | 10 | 10 | 10 | 10 | 10 | 10 | 10 | 10 | 10 | 10 | 10 | 10 |
| G14 | 10 | 10 | 10 | 10 | 10 | 10 | 10 | 10 | 10 | 10 | 10 | 10 | 10 | 10 | 10 | 10 | 10 | 01 |
| G13 | 10 | 10 | 10 | 10 | 10 | 10 | 10 | 10 | 10 | 10 | 10 | 10 | 10 | 10 | 10 | 10 | 01 | 01 |
| G12 | 10 | 10 | 10 | 10 | 10 | 10 | 10 | 10 | 10 | 10 | 10 | 10 | 10 | 10 | 10 | 01 | 01 | 01 |
| G11 | 10 | 10 | 10 | 10 | 10 | 10 | 10 | 10 | 10 | 10 | 10 | 10 | 10 | 10 | 01 | 01 | 01 | 01 |
| G10 | 10 | 10 | 10 | 10 | 10 | 10 | 10 | 10 | 10 | 10 | 10 | 10 | 10 | 01 | 01 | 01 | 01 | 01 |
| G9 | 10 | 10 | 10 | 10 | 10 | 10 | 10 | 10 | 10 | 10 | 10 | 10 | 01 | 01 | 01 | 01 | 01 | 01 |
| G8 | 10 | 10 | 10 | 10 | 10 | 10 | 10 | 10 | 10 | 10 | 10 | 01 | 01 | 01 | 01 | 01 | 01 | 01 |
| G7 | 10 | 10 | 10 | 10 | 10 | 10 | 10 | 10 | 10 | 10 | 01 | 01 | 01 | 01 | 01 | 01 | 01 | 01 |
| G6 | 10 | 10 | 10 | 10 | 10 | 10 | 10 | 10 | 10 | 01 | 01 | 01 | 01 | 01 | 01 | 01 | 01 | 01 |
| G5 | 10 | 10 | 10 | 10 | 10 | 10 | 10 | 10 | 01 | 01 | 01 | 01 | 01 | 01 | 01 | 01 | 01 | 01 |
| G4 | 10 | 10 | 10 | 10 | 10 | 10 | 10 | 01 | 01 | 01 | 01 | 01 | 01 | 01 | 01 | 01 | 01 | 01 |
| G3 | 10 | 10 | 10 | 10 | 10 | 10 | 01 | 01 | 01 | 01 | 01 | 01 | 01 | 01 | 01 | 01 | 01 | 01 |
| G2 | 10 | 10 | 10 | 10 | 10 | 01 | 01 | 01 | 01 | 01 | 01 | 01 | 01 | 01 | 01 | 01 | 01 | 01 |
| G1 | 10 | 10 | 10 | 01 | 01 | 01 | 01 | 01 | 01 | 01 | 01 | 01 | 01 | 01 | 01 | 01 | 01 | 01 |
| G0 | 01 | 01 | 01 | 01 | 01 | 01 | 01 | 01 | 01 | 01 | 01 | 01 | 01 | 01 | 01 | 01 | 01 | 01 |

TABLE 3

| write-in gray level data | Voltage |
|---|---|
| 00 | V_{POS} (+15 volts) |
| 01 | V_{NEG} (−15 volts) |
| 10 | V_{SS} (0 volt) |
| 11 | X |

The lookup table capacity of TABLE 2 is equal to 16 (i.e. total gray levels)×18 (i.e. total frames)=288 bits. When TABLE 2 is applied to a color electrophoretic display device in which each pixel comprises a red sub-pixel, a green sub-pixel, and a blue sub-pixel, three lookup tables can be stored for the red sub-pixel, the green sub-pixel, and the blue sub-pixel, respectively. The capacity of the three lookup tables is equal to 288×3=864 bits. For the color electrophoretic display device, the lookup table capacity according to the present invention is only 1/16 of the lookup table capacity in the prior art.

Since the lookup table capacity is significantly decreased, a saving of capacity can be used for storing a plurality of lookup tables for different situations. For example, the lookup tables are used for different sub-pixels or different temperatures. As a result, the display quality of the electrophoretic display device can be improved by looking up different lookup tables under different situations.

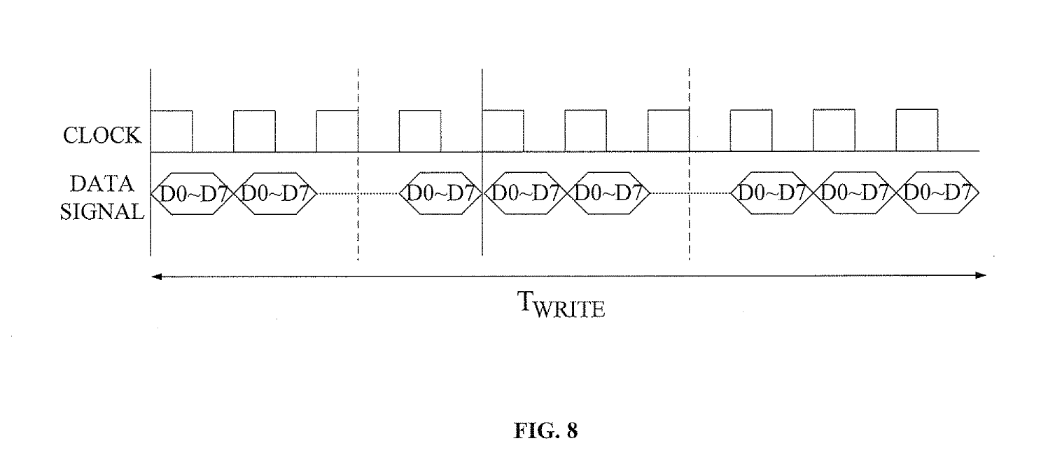

Please refer to FIG. 6, FIG. 7, and FIG. 8. FIG. 8 illustrates a timing chart showing the source data signal inputted to the source driving circuit by the controller. In the present embodiment, the source data signal S_{SD} inputted to the source driving circuit 604 by the controller 600 per time comprises 8 bits. The 8 bits are denoted as D7-D0. D7-D0 are provided in a clock period as shown in FIG. 8. Since each of the pixels 630 requires 2 bits, the gray level data of four pixels 630 are provided by the controller 600 per time. In the timing chart of FIG. 8, the write-in time T_{WRITE} includes the required time for providing the gray level data of all pixels 630 in one complete image by the controller 600. The gray level data of the pixels 630 are sequentially provided (i.e. not at the same time) by the controller 600.

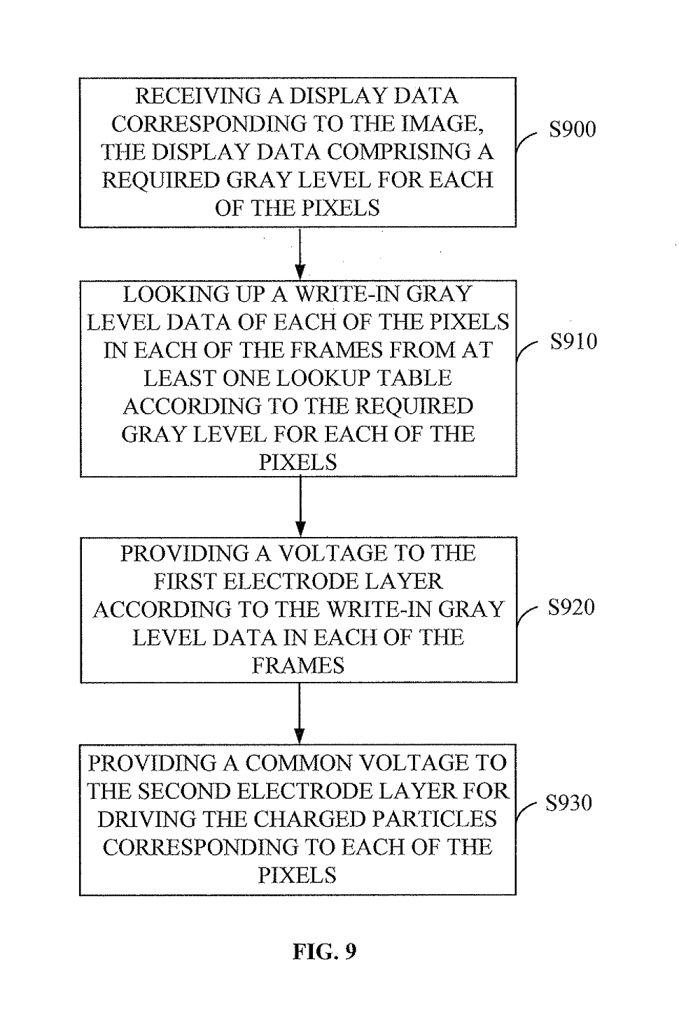

Please refer to FIG. 9, which illustrates a flow chart of a method for driving an electrophoretic display device according to the present invention. The electrophoretic display device comprises a first electrode layer, a second electrode layer corresponding to the first electrode layer, and an electrophoretic layer which is disposed between the first electrode layer and the second electrode layer. The first electrode layer has a plurality of pixels formed thereon. The electrophoretic layer comprises a plurality of charged particles. Each of the pixels is corresponding to several of the charged particles. The electrophoretic layer is used for displaying at least one image. The image comprises a plurality of frames.

In step S900, a display data corresponding to the image is received. The display data comprises a required gray level for each of the pixels.

In step S910, a write-in gray level data of each of the pixels in each of the frames is looked up from at least one lookup table according to the required gray level for each of the pixels. The lookup table records the write-in gray level data of each of the pixels in each of the frames from a reference gray level to the required gray level. The reference gray level may be a lowest gray level or a highest gray level.

In step S920, a voltage is provided to the first electrode layer according to the write-in gray level data in each of the frames.

In step S930, a common voltage is provided to the second electrode layer. An electric field formed between the first electrode layer and the second electrode layer through each of the pixels drives the charged particles corresponding to each of the pixels.

In one embodiment, the write-in gray level data of each of the pixels in each of the frames is looked up from a plurality of lookup tables. The lookup tables are used for different temperatures. In another embodiment, each of the pixels comprises a plurality of sub-pixels. The write-in gray level data of each of the pixels in each of the frames is looked up from a plurality of lookup tables. The lookup tables are used for different sub-pixels.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular fol ins as illustrated, and that all modifications and alterations which maintain the spirit and realm of the present invention are within the scope as defined in the appended claims.

What is claimed is:

1. An electrophoretic display device, used for displaying at least one image, the image comprising a plurality of frames, the electrophoretic display device comprising:
a first electrode layer having a plurality of pixels formed thereon;
a second electrode layer corresponding to the first electrode layer and electrically coupled to a common voltage;
an electrophoretic layer disposed between the first electrode layer and the second electrode layer, the electrophoretic layer comprising a plurality of charged particles, each of the pixels corresponding to several of the charged particles; and
a controller, receiving a display data corresponding to the image, the display data comprising a required gray level for each of the pixels, the controller looking up a write-in gray level data of each of the pixels in each of the frames from at least one lookup table according to the required gray level for determining a voltage, the lookup table recording the write-in gray level data of each of the pixels in each of the frames from a reference gray level to the required gray level, the voltage being provided to the first electrode layer, and an electric field formed between the first electrode layer and the second electrode layer through each of the pixels for driving the charged particles corresponding to each of the pixels.

2. The electrophoretic display device of claim 1, wherein the write-in gray level data of each of the pixels in each of the frames is looked up from a plurality of lookup tables, and the lookup tables are used for different temperatures.

3. The electrophoretic display device of claim 1, wherein each of the pixels comprises a plurality of sub-pixels, the write-in gray level data of each of the pixels in each of the frames is looked up from a plurality of lookup tables, and the lookup tables are used for different sub-pixels.

4. The electrophoretic display device of claim 1, further comprising a memory unit for storing the lookup table.

5. The electrophoretic display device of claim 1, wherein the reference gray level is a lowest gray level or a highest gray level.

6. The electrophoretic display device of claim 1, further comprising a power supply unit for providing the voltage and the common voltage.

7. The electrophoretic display device of claim 1, further comprising a source driving circuit for transforming the write-in gray level data looked up from the lookup table by the controller into the voltage and transmitting the voltage to the first electrode layer.

8. The electrophoretic display device of claim 1, wherein the first electrode layer is an indium tin oxide layer, and the first electrode layer is manufactured on a thin film transistor substrate.

9. The electrophoretic display device of claim 1, wherein the second electrode layer is an indium tin oxide layer, and the second electrode layer is manufactured on a color filter substrate.

10. A method for driving an electrophoretic display device, the electrophoretic display device comprising a first electrode layer, a second electrode layer corresponding to the first electrode layer, and an electrophoretic layer disposed between the first electrode layer and the second electrode layer, the first electrode layer having a plurality of pixels formed thereon, the electrophoretic layer comprising a plurality of charged particles, each of the pixels corresponding to several of the charged particles, the electrophoretic display device used for displaying at least one image, the image comprising a plurality of frames, the method comprising:
receiving a display data corresponding to the image, the display data comprising a required gray level for each of the pixels;
looking up a write-in gray level data of each of the pixels in each of the frames from at least one lookup table according to the required gray level for each of the pixels, the lookup table recording the write-in gray level data of each of the pixels in each of the frames from a reference gray level to the required gray level;
providing a voltage to the first electrode layer according to the write-in gray level data in, each of the frames; and
providing a common voltage to the second electrode layer, and an electric field being formed between the first electrode layer and the second electrode layer through each of the pixels for driving the charged particles corresponding to each of the pixels.

11. The method for driving the electrophoretic display device of claim 10, wherein the write-in gray level data of each of the pixels in each of the frames is looked up from a plurality of lookup tables, and the lookup tables are used for different temperatures.

12. The method for driving the electrophoretic display device of claim 10, wherein each of the pixels comprises a plurality of sub-pixels, the write-in gray level data of each of the pixels in each of the frames is looked up from a plurality of lookup tables, and the lookup tables are used for different sub-pixels.

13. The method for driving the electrophoretic display device of claim 10, wherein the reference gray level is a lowest gray level or a highest gray level.
